(19) United States
(12) Patent Application Publication
(10) Pub. No.: US 2021/0209666 A1
(43) Pub. Date: Jul. 8, 2021

(54) DIGITAL DATA EXCHANGE SYSTEM AND METHOD

(71) Applicant: ELECTRONIC CREDIT SYSTEMS, INC., Highland Park, IL (US)

(72) Inventor: Robert Bernstein, Highland Park, IL (US)

(21) Appl. No.: 17/143,453

(22) Filed: Jan. 7, 2021

Related U.S. Application Data
(60) Provisional application No. 62/957,915, filed on Jan. 7, 2020.

(51) Int. Cl. G06Q 30/06; G06F 16/9535; G06F 9/451

(52) U.S. Cl. CPC G06Q 30/0631; G06F 16/9535; G06F 9/451; G06Q 30/0611; G06Q 30/0643

(57) ABSTRACT

A digital data exchange system includes a controller configured to receive a request message from a personal computing device of a first party. The request message includes information about at least one desired product or service. The controller is configured to communicate the request message to vendor computing devices of multiple vendors. Responsive to receiving one or more response messages from the vendor computing devices, the controller is configured to communicate the one or more response messages or information from the one or more response messages to the personal computing device of the first party. Each of the one or more response messages includes one or more of an offer for sale of the at least one desired product or service or promotional material related to the at least one desired product or service, and is generated upon receipt of the request message at the respective vendor computing device.

### CROSS-REFERENCE TO RELATED APPLICATIONS

This application relates to and claims priority benefits from U.S. Provisional Application No. 62/957,915, entitled “Digital Data Exchange System,” filed 7 Jan. 2020, which is incorporated herein by reference in its entirety.

### FIELD

The subject matter herein relates to controlling access to data between multiple parties via a computerized system.

### BACKGROUND

The distribution of promotional materials according to conventional processes is inefficient. Although advertisers may target a particular type of consumer, the communication medium used to reach that particular consumer, such as radio, Internet, television, and magazine, may either be too broad or too narrow in the scope of the audience that the promotional material reaches. Consumer privacy concerns further complicate the process of identifying and reaching desired consumers. Accordingly, a need exists for a better method of identifying potential consumers and distributing promotional materials to the potential consumers.

### SUMMARY

In one or more embodiments, a digital data exchange (DDE) system is provided that includes a controller and a memory. The DDE system may be an independent, trusted, secure intermediary between multiple parties, such as consumers and merchants that provide goods and/or services to consumers. The DDE system protects the privacy of the parties, and is driven by purchase data and other data. Additionally, the DDE system can function as a broker, financial intermediary, or data depository. The DDE system may function as a third party intermediary for distribution of promotional material, transactions, distribution of product and/or service information, and the like. The DDE system can be used by individual consumers as well as companies, such as merchants, insurance companies, or the like. The DDE system may have awards or points programs and may fact check data from any source.

In one or more embodiments, a DDE system is provided that includes a controller including one or more processors. The controller is configured to receive a request message from a personal computing device of a first party. The request message includes information about at least one desired product or service. The controller is configured to communicate the request message to vendor computing devices of multiple vendors. Responsive to receiving one or more response messages from the vendor computing devices, the controller is configured to communicate the one or more response messages or information from the one or more response messages to the personal computing device of the first party. Each of the one or more response messages includes one or more of an offer for sale of the at least one desired product or service or promotional material related to the at least one desired product or service, and is generated upon receipt of the request message at the respective vendor computing device.

In one or more embodiments, a method for exchanging digital data is provided. The method includes receiving, at a controller that includes one or more processors, a request message from a personal computing device of a first party, and communicating the request message to vendor computing devices of multiple vendors. The request message includes information about at least one desired product or service. Responsive to receiving one or more response messages from the vendor computing devices, the method includes communicating, via the controller, the one or more response messages or information from the one or more response messages to the personal computing device of the first party. Each of the one or more response messages includes one or more of an offer for sale of the at least one desired product or service or promotional material related to the at least one desired product or service, and is generated upon receipt of the request message at the respective vendor computing device.

In one or more embodiments, a DDE system is provided that includes a controller including one or more processors. The controller is configured to receive a request message from a personal computing device of a first party, and to communicate the request message to vendor computing devices of multiple vendors without revealing personal information of the first party to any of the vendors. The request message includes information about at least one desired product or service. In response to receiving multiple response messages from the vendor computing devices, the controller is configured to compile information from the response messages into an offer message and communicate the offer message to the personal computing device of the first party. Each of the response messages includes one or more of an offer for sale of the at least one desired product or service or promotional material related to the at least one desired product or service, and is generated upon receipt of the request message at the respective vendor computing device.

### BRIEF DESCRIPTION OF THE DRAWINGS

FIG. 1 is a block diagram illustrating a DDE system formed in accordance with one or more embodiments.

FIG. 2 is a flow chart of a method for exchanging digital data according to one or more embodiments.

### DETAILED DESCRIPTION

Embodiments of the inventive subject matter describe a DDE system that allows a first party, such as an individual consumer, to anonymously, indirectly communicate with other parties via the DDE system. The other parties may be vendors, such as merchants that sell goods, companies that provide services, and/or the like. The DDE system can be utilized by a consumer to search for a desired product or service itself, or for information about the desired product or service. The information sought can include reviews, promotional materials (e.g., sales offers, discounts, and the like), information about how to locate and purchase the desired product or service (e.g., which stores have the product in stock), or the like.

The DDE system may collect information from the first party. As used herein, the first party is also referred to as a consumer, but the first party is not limited to an individual consumer. For example, the first party can include a company, a group of people, or the like that desires a product, a service, or information about a product or service. The DDE system collects purchase information and other data via a software application or website that is utilized by the consumer. For example, the purchase information may include digital receipts for purchases made by the consumer, promotional material that is emailed to the consumer, historical purchase data of the consumer, information about a product or service that the consumer desires to purchase but has not purchased before, and/or the like. Through the application the DDE system assigns a unique identifier to the consumer that is known only to the DDE system, so privacy is maintained. The consumer may selectively upload the purchase information to the DDE system, where the purchase information is stored into a data library, or database, of the DDE system. The information selected by the consumer to be stored in the data library is uniquely associated with an account of the consumer. For example, the data library may include a profile that is unique to the consumer and other profiles that are unique to other consumers. The consumer can control the contents of the associated profile in the data library via the software application or website.

When the consumer wants to connect with a vendor (e.g., merchant or service provider), the consumer uses the DDE system to generate a request message. For example, the consumer may seek current promotional opportunities or offers for a specific product or service that is desired by the consumer. The consumer can select information, which is relevant to the desired product or service, from the profile associated with the consumer to be included in the request message. The request message can include selected items from the profile that best define or describe what the consumer desires from a vendor. The items may be selected manually or in combination with artificial intelligence. Selection may be verbal or through a voice-based digital assistant device (e.g., Siri or Alexa). Encryption may be used to enhance security. For example, the information and/or items selected may include a receipt from a previous purchase of the desired product or service, an entry in a search history of a linked application or website, an entry from a calendar or planner, a keyword from a message in a linked electronic mail (e.g., email) account, a photograph of a product or service, an outdated promotional offer, or the like. The request message includes only the information that the consumer wants to share. The consumer can also enter additional information to be included in the request message, such as specific instructions or details about the desired product or service. The consumer can use a DDE system-based remote application on a computer device, such as a mobile phone, tablet computer, laptop computer, or desktop computer, to generate the request message. The request message is then communicated to a controller (e.g., a control unit or circuit) of the DDE system.

The controller of the DDE system analyzes the request message received from the computer device of the consumer. The controller may utilize one or more processors, artificial intelligence (AI), machine-learning, and/or the like to analyze the request message. The request message itself, or information from the message, is made accessible by the controller to other parties affiliated with the DDE system through a secure communication network. The controller functions as a filter and intermediary between the various parties, ensuring anonymity between the parties that communicate. The other parties can include vendors such as merchants, service providers, and/or the like, which can receive or access the request message of the consumer. The vendors may also include financial institutions (e.g., banks, brokers, clearing houses, financial advisers, accountants, etc.), contractors (e.g., builders, plumbers, roofers, etc.), retailers, restaurants, transportation companies, and various other types of businesses that provide goods and/or services to consumers. The controller may filter the request message based on different classes or categories of vendors on the other side, such that vendors in each class or category receive information from the request message that is relevant to those specific vendors. For example, if a request message includes multiple items, such as a request for dining and transportation, the controller may make the portion of the request message describing the dining request available to restaurants that use the DDE system and may make a different portion of the request message describing the transportation request available to transportation service companies, such as public transportation, taxi companies and ride-share companies.

The controller may utilize AI to determine trends based on the activity of large numbers of users of the DDE system, and may enhance or refine the request messages based on the trends that are determined. During the generation of the request message, the controller may prompt the consumer with suggestions based on the activity trends of other consumers that use the DDE system. If the consumer selects vegetarian groceries, or otherwise indicates that the consumer is vegetarian, the controller may ask the consumer, via a displayed user interface on the personal computing device of the consumer, whether the consumer would be interested in other items that are determined, based on the activity (e.g., purchasing) trends, to be popular for consumers interested in vegetarian groceries. For example, the controller may prompt the consumer to determine interest in a delivery service that would deliver the groceries to the consumer's residence. Furthermore, the controller may ask if the consumer is also interested in receiving offers for other items that may be relevant to the consumer based on activity trends of other consumers interested in vegetarian groceries, such as gardening.

The vendors that are interested in communicating with the consumer can provide a response message to the DDE system to be relayed to the consumer via the controller. The response message is the reply to the consumer request message that is sent to the consumer via the DDE system. Each response message may include information (e.g., a packet of data) responsive to the consumer request, such as information that answers the consumer request. This information may be simply an offer or it may be expanded to include relevant references. The response may be in the form of a checklist. In the example above in which the request message seeks promotional material concerning a desired product or service, each response message from different vendors may include promotional material for the desired product or service that is currently offered by the particular vendor that is the source of the response message. The controller of the DDE system then forwards the response message(s) to the consumer via the secure communication network.

Optionally, the controller may be configured to curate, enhance, or modify the response messages prior to communicating the response messages to the consumer. For example, the controller may consolidate the promotional material into a single consolidated response message that is delivered to the computer device of the consumer. The consolidated response message may include information, such as promotional material, from multiple different responding parties (e.g., different vendors) arranged together. The arrangement may be in a list, an array, a graph, or the like. The compilation of information from multiple different vendors enables the consumer, upon receipt of the response message, to easily compare the information and make a selection. The controller of the DDE system may also enhance the information received from the responding party or parties, such as by adding relevant information to the response messages that may be useful to the requesting party (e.g., the consumer). The relevant information can include geographic information of the responding vendors, general consumer ratings of the responding vendors, historical sale data of the responding vendors, or the like. A dialogue may ensue between parties via the DDE system, while maintaining the anonymity of the consumer and avoiding exposing the consumer to annoying and distracting “push” marketing.

One or more technical effects of the DDE system described herein include increased efficiency and enhanced ability for independent parties or organizations to connect with each other and/or integrate with other vertical or horizontal parties to serve patrons. A technical effect also includes protecting the requesting party from identity theft and irritating push marketing that uses the contact information of the requesting party. For example, the consumer operates anonymously and privately on the DDE system unless and until the consumer chooses to provide contact information to a responding party. Another technical effect can include that the DDE system, acting as an intermediary, can curate a response message provided to a requesting party (e.g., the consumer) to include consolidated information from multiple responding parties (e.g., vendors) and/or additional relevant information to the requesting party that was absent from the information supplied by the responding parties. For example, the DDE system can compile the information received from multiple responding parties to a single request message, which enables the requesting party to compare the information. The DDE system may also analyze the information received from the vendors to provide suggestions or recommendations based on promotional offers, the purchasing trends of other consumers, and/or the like. The DDE system may provide seamless commerce through an interconnected multifunction intermediary, while enabling detailed input from all parties.

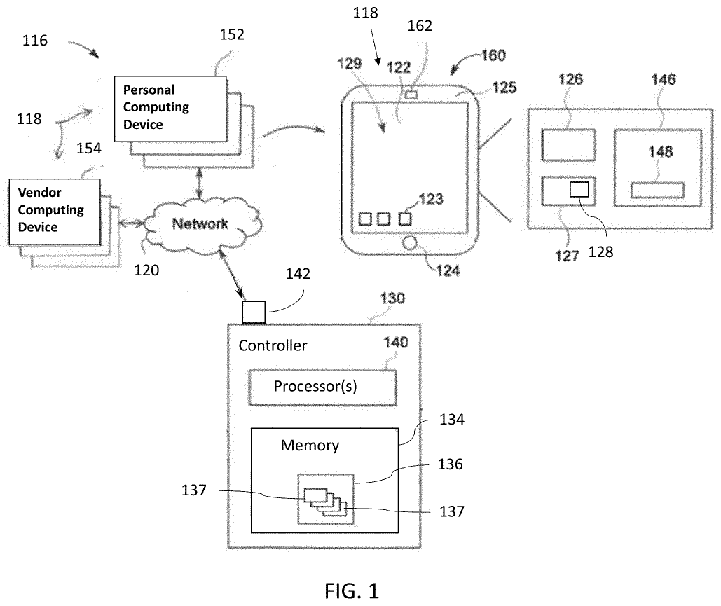

FIG. 1 is a block diagram illustrating a DDE system 116 formed in accordance with embodiments herein. The DDE system 116 includes client computing devices 118 that are capable of communicating over a network 120 with a controller 130 (e.g., a control unit or circuit) of the DDE system 116. The client computing devices 118 include both personal computing devices 152 of consumers and the computing devices 154 of vendors. In at least one embodiment, the personal computing devices 152 and the vendor computing devices 154 indirectly communicate with each other via the network 120 and the controller 130.

The controller 130 of the DDE system 116 performs at least some of the operations described herein to control the exchange of information between the client computing devices 118. The controller 130 represents hardware circuitry that includes and/or is connected with one or more processors 140 (e.g., one or more microprocessors, integrated circuits, microcontrollers, field programmable gate arrays, etc.). In an embodiment, the controller 130 may represent all or a portion of one or more servers. For example, the controller 130 may represent only a single server or a plurality of different servers that communicate with one another and the client computing devices 118 over the network 120. The controller 130 may be located at a remote computing facility, such as a cloud computing facility.

The controller 130 includes and/or is connected with at least one tangible and non-transitory computer-readable storage medium (e.g., memory) 134. For example, one or more processors 140 are communicatively connected to the at least one memory 134. The memory 134 may store programmed instructions (e.g., software) that is executed by the one or more processors 140 to perform the operations of the controller 130 described herein. The programmed instructions can instruct the one or more processors 140 how to analyze received messages, such as request messages, how to extract and/or forward information from received messages, and/or where to direct such information from the received messages. The programmed instructions can also instruct the one or more processors 140 how to generate messages, such that the messages trigger the display of specific content to a user on a client computing device 118. The memory 134 may store different information, such as a user profile database 136 that stores individual user profiles 137 associated with each respective user (e.g., consumer, vendor, etc.) that uses the DDE system 116. The memory 134 optionally may store or record an activity or transaction history of the DDE system 116 in general, such as copies of request messages and response messages that are transmitted to and from the controller 130. The memory 134 also may store a directory of vendors that utilize the DDE system 116. The directory can include identification information for each vendor, contact information, and a description of products and/or services that the vendor can provide. The processors 140 of the controller 130 may consult the directory to determine which vendors would be relevant for a specific request message. For example, if the request message identifies a particular food item sold at a grocery store, such as a type of wine, the directly can be used to determine which vendors would be interested in receiving requests for wine. The relevant vendors in this case could be grocery stores, specialty wine stores, wineries, and/or the like.

The user profile database 136, or data library, may be a digital file with cross-indexing in which the consumers can control input and output of their respective personal user profiles 137. Furthermore, each consumer can add, delete, and/or edit entries in their personal user profile 137 at any time by successfully logging into the DDE system 116 and authenticating. Entries can include purchase receipts, keywords, personal data, search history, donations, promotional data, other receipts, and/or useful information. Entries from purchases may be sent directly from point of sale, may be translated by the DDE system, and/or may be forwarded from the consumer. For example, the user profile 137 of the DDE system 116 can serve as a vault or protected file depository for financial transactions, storing various types of receipts and associated information (e.g., day and time of transaction, description of product or service, etc.) as confirmations of the transactions. Receipts may be organized in different categories, such as personal or business. Copies of receipts can be selectively forwarded, via the controller 130, to accountants for taxes or expense accounts. For example, a consumer can use a mobile application 146 of the DDE system 116, as described herein, to select specific entries from the user profile 137 to be communicated, by the controller 130, to a designated accountant. The profile database 136 optionally may include a sub-section or vault for important personal information, such as medical information accessible to first responders or a file describing assets, which would be useful for heirs.

The controller 130 may be operably coupled to a communication device 142 that enables the controller 130 to send and receive information via the network 120. The communication device 142 can represent circuitry that can communicate electrical signals wirelessly and/or via wired connections. For example, the communication device can represent transceiving circuitry, one or more antennas, modems, routers, or the like. The transceiving circuitry may include a transceiver or separate transmitter and receiver devices. The electrical signals can form data packets that in the aggregate represent messages, such as request messages and response messages. In various embodiments, the controller 130 can generate messages that are communicated remotely by the communication device 142. The communication device 142 can receive messages and forward the messages to the controller 130 for analysis of the received messages.

The controller 130 may include one or more application servers and, optionally, one or more web servers. The controller 130 may host a mobile application 146 associated with the DDE system 116 and has the tools, application program interfaces (APIs), and scripts, among other things, that may be used for the mobile application 146. For example, the users of the DDE system 116 may download the mobile application 146 for the DDE system 116 onto their client computing devices 118. To access the DDE system 116, a user may open or initiate the mobile application 146 on a respective client computing device 118. The mobile application 146 can provide one or more user interfaces and/or web-based pages that allow a user to view their personal account information and history of activity with the DDE system 116. The mobile application 146 may require at least one form of authentication (e.g., password, security code on a trusted device, face or other biological recognition, or the like) before granting the user access to a personal account. Via the mobile application the user can selectively upload purchase information (e.g., receipts, promotional material, etc.) to be stored in the respective user profile in the data library, generate request messages, view response messages to previously-generated request messages, open dialogues with vendors that responded to previously-generated request messages, and the like.

The controller 130, in some embodiments, is configured to receive and interpret requests through the network 120 from the client computing devices 118 (or, more specifically, from software applications 146 on the computing devices 152, 154). The controller 130 is also configured to respond to the requests and transmit data via electrical signals to the client computing devices 118 in a predetermined format (e.g., HTML format). In some cases, the controller 130 and the client computing devices 118 may form a cloud-type computing system (e.g., public cloud, private cloud, or hybrid cloud). The network 120 represents one or more of a cable network, the Internet, a private intranet, a local area network, a wide area network, a wireless network, or the like. In particular embodiments, the network 120 includes the Internet. The communication pathways between the controller 130 and the client computing devices 118, including the consumer personal computing devices 152 and the vendor computing devices 154, may be defined by wireless segments and wired segments. For example, a personal computing device 152 may wirelessly communicate with one or more cell towers, and the cell towers may communicate through a wired connection to the controller 130 at a remote cloud storage facility to complete the communication pathway.

The client computing devices 118 may be implemented as various types of computing devices. These computing devices may include, for instance, smart phones, personal computers (PCs), tablet computers, notebook computers, laptop computers, electronic book readers, personal data assistant (PDA) devices, video game consoles, and so forth. In particular embodiments, the personal computing devices 152 may include portable or handheld devices, such as smart phones or tablet computers. A portable or handheld device is relatively lightweight (e.g., less than six pounds) such that an average adult individual may keep the device on their person, such as in a pocket or a handbag. In FIG. 1, the computing device is illustrated as a tablet computer 160. Data displayed on the portable devices may include, among other things, images, video, text-based messages, or the like. The vendor computing devices 154 may include any of the types of computing devices listed above, and may also include computing devices integrated into and specifically associated with a business or store, such as a computer at a point of sale terminal.

The client computing devices 118 (including both the personal and vendor computing devices 152, 154) are configured to operate the mobile application 146 of the DDE system 116. Optionally, the mobile application 146 may be configured to work with sub-applications 148 or scripts (e.g., plug-ins or extensions) that are executed from within the application program or in concert with the application program. The sub-application 148 runs or is executed concurrently with the application program 146. Optionally, the sub-application 148 may be stored within the client computing devices 118 and/or the controller 130. The mobile application 146 may be or include third-party software that retrieves and communicates information through the network 120. The mobile application 146 on the client computing devices 118 communicates with the controller 130 over the network 120. The mobile application 146 may communicate using, for example, a known protocol (e.g., Hypertext Transfer Protocol (HTTP) or HTTP-secure (HTTPS)). More specifically, the mobile application 146 may send requests (e.g., HTTP requests) for information to any web-accessible internet address. The mobile application 146 may also display the information on the respective client computing device 118 in accordance with a predetermined format (e.g., HTML format). The sub-applications 148 may be launched from within the mobile application 146 and, optionally, communicate with the controller 130 to retrieve information that may be displayed to the user through the mobile application 146. Embodiments set forth herein may be implemented, at least in part, using the mobile application 146, a sub-application 148 associated with the mobile application 146, or other software program having computer executable code.

The tablet computer 160 shown in FIG. 1 includes a user display 122. The user display 122 optionally may be touch-sensitive (e.g., include a touchscreen) that is configured to identify and locate a touch from a user's finger or stylus. The user display 122 is framed by a housing 125 of the tablet computer 160. The user display 122 defines an area presents a graphical user interface for interacting with the mobile application 146 of the DDE system 116. The graphical user interface may include virtual user-selectable elements 123 (e.g., virtual buttons) that may be selected by the user on the user display 122. Alternatively or in addition to the user-selectable elements 123, a user may select tangible or physical user-selectable elements 124 (e.g., buttons, switches, or the like). The tablet computer 160 may also include at least one camera 162 for generating image data. For example, a consumer can use the camera 162 on the tablet computer 160 to generate an image of a printed purchase receipt, a bar or QR code, a model number associated with a specific product, and/or the like, and then can upload the image to the DDE system 116 via the mobile application 146 to store the image in the consumer's personal, private user profile 137.

The tablet computer 160 may include one or more processors 126 and at least one computer-readable storage medium (e.g., memory) 127. The memory 127 may store program instructions for a display application, such as the mobile application 146. The mobile application 146 is configured to display various graphical user interfaces, images, and the like on the user display 122 to present information to the user and prompt the user for responses. The program instructions stored in the memory 127 may instruct the one or more processors 126 how to unpack a received message, render and then display the graphical user interfaces, images, and the like on the user display 122. Via the program instructions, the one or more processors 126 may control the tablet computer 160 (and/or other linked devices such as smart watches) to alert the user when a message is received, such as by vibrating, generating an audible notification sound, displaying a text-based notification message on the user display 122, and/or the like. In some embodiments, the memory 127 may store program instructions for the sub-application 148. Optionally, the sub-application 148 may be a plug-in or extension that is executable within or by the mobile application 146.

In one or more embodiments, the memory 127 of the tablet computer 160 (or other client computing device 118) may include a local data library 128 associated with the mobile application 146. The local data library 128 may store entries selected by the consumer, such as receipts, at least temporarily. In an embodiment, receipts and other entries uploaded by the consumer are first stored in the local data library 128, and subsequently are communicated via the network 120 to the profile database 136 and stored in the specific user profile 137 associated with the particular consumer. For example, the consumer may generate a request message that includes a receipt from the local data library 128. Upon receipt of the request message, the controller 130 stores the request message, or at least the receipt thereof, in the user profile 137 of the profile database 136.

The following are non-limiting example use cases of the DDE system 116 according to one or more embodiments. In a first example, a consumer can use the DDE system 116 to request offers for specific goods or services by submitting an open request with the DDE system 116. For example, the consumer can open the mobile application 146 on the personal computing device 152 of the consumer, and log in to his or her account to access the contents of the local data library 128. The consumer can select an item from the local data library 128 associated with a desired product or service, such as a receipt from a prior purchase of the desired product or service. The item in the local data library 128 can alternatively be a promotion directed to the desired product or service, a search term that describes the desired product or service, or the like. After selecting the item or entry, the mobile application 146 may prompt the consumer whether to generate a request message for the desired product or service. The consumer uses the graphical user interface and user input devices of the personal computing device 152 to consent to the generation of the request message. The consumer can customize the request message by constraining or limiting the search to specific time periods, geographic regions, and/or price ranges. For example, the consumer can request a specific type of sporting equipment within a specific geographic proximity of the consumer's location and within a specific price range. The request message in this embodiment is an open request for a specific type of product at a specific price point.

The request message is communicated from the personal computing device 152 to the controller 130 via the network 120. The controller 130 analyzes content of the request message that is received. The controller 130 is configured to enable different vendors to view the open request and establish a dialogue or other interaction with the consumer that generated the open request for the purpose of transacting for the desired product or service while maintaining the confidentiality and anonymity of the consumer. In an embodiment, the controller 130 filters a broad list of vendors that are connected to the DDE system 116 to determine a subset of the vendors that would be relevant to the particular request message. For example, if the request message seeks a specific type of sporting equipment, such as a baseball glove, the controller 130 can determine which vendors connected to the DDE system 116 sell baseball gloves or are otherwise related to baseball. The controller 130 may also filter vendors based on other criteria, such as proximity to the location of the consumer.

The controller 130 may forward the request message that is received, or a modified request message that is generated by the controller 130 based on the received request message, to the vendor computing devices 154 of the subset of vendors determined to be relevant to the inquiry. The request message or modified request message may identify the particular product that is desired, such as a baseball glove, by brand, model, size, condition (e.g., used or new), etc., as well as providing other constraints such as price limits, time limits (e.g., available for sale now), etc. Upon receipt of the request message or the modified request message, the vendors that are interested in communicating with the consumer that generated the request message can generate a response message that is communicated from the vendor computing device 154 back to the controller 130. The response message can indicate the availability of the desired product, such as whether has the desired product in stock or when the product could be shipped to the consumer, how many items of the desired product are available, a cost of the desired product, a promotion involving the desired product or related products, and other relevant information to the consumer for purchasing the desired product. For example, the response message generated by a given vendor may include instructions for completing a transaction, such as payment instructions, contact information that offers the consumer to contact the vendor directly, or the like.

In an example, the controller 130 may receive multiple response messages from different vendors. In one embodiment, the controller 130 may forward each of the response messages to the personal computing device 152 of the consumer that generated the request message. Upon receipt of each response message, the personal computing device 152 may be controlled, via software of the DDE mobile application 146, to alert or notify the consumer via vibration, audible noise, or a visual, text-based message. Stated differently, upon receipt of a response message, the DDE mobile application 146 may generate a control signal to cause the personal computing device 152 and/or a peripheral computing device connected to the personal computing device 152 (e.g., a smartwatch) to emit a noise, emit a vibration, and/or to display a message to notify the consumer that the response message has been received. Alternatively, the response messages may not be communicated to the personal computing device 152 until the consumer logs into the personal account of the DDE system 116. The consumer can view the response messages and decide whether or not to contact any of the vendors that sent the response messages (e.g., establish a dialogue with the vendor for the purpose of purchasing the desired product). Optionally, the consumer can reach out to one or more of the vendors via the DDE system 116, maintaining anonymity of the consumer during the entire process. Optionally, the controller 130 may also function as a financial intermediary that processes credit card information and the like for the transaction. Alternatively, the financial details may be handled by a third party company or directly between the transacting parties, not by the DDE system 116.

In another embodiment, the controller 130 may receive and analyze the response messages to curate the information from the response messages into an enhanced response message, referred to herein as an offer message. The controller 130 may compile the information from multiple response messages into the single offer message, and may present the information in a list or chart. The list may be arranged or sorted based on various factors, such as offered sale price of the product from least to most expensive, proximity of the vendor to the consumer, or the like. In this embodiment, the controller 130 may receive multiple response messages, but then may only communicate a single offer message to the personal computing device 152 of the consumer that generated the request message. The offer message may be organized to clearly present the offers to the consumer, enabling the consumer to quickly compare the various offers from the different vendors to select the best offer to pursue according to the consumer's preferences. The consumer may be able to select a desired offer from the list of multiple offers using an input device of the personal computing device, such as a touchscreen, a mouse, a keyboard, or the like. Upon selection of the desired offer, the DDE system 116 may provide a means for connecting the consumer directly to the vendor, such as generating and displaying a link directing the consumer to a page on the vendor's web site specifically generated for the consumer. The page may include the offer details, such as a full description of the terms of the offer and a contact number for speaking with a member of the vendor. The page may also request payment information from the consumer to complete the transaction.

The DDE system 116 enables consumers to proactively reach out and request specific products and services that are sought, encouraging connected vendors (e.g., merchants and service providers) to supply competitive offers without enabling vendors to receive personal contact information of the consumer.

In a second example use case, a consumer buys a ticket to a concert. The ticket includes the description of the performance (e.g., the musical group or artist), the location or venue, the date, and optionally price. The consumer can select to upload the ticket purchase receipt to the local data library 128 in the personal computing device 152 associated with the DDE mobile application 146. In the mobile application 146, the consumer can select the ticket as an item on which to generate a request message. For example, the consumer can further specify types of products or services, associated with the concert, which are sought or desired by the consumer. As an example, the consumer can select “transportation”, “dining”, “artist merchandise and/or recordings”, and/or the like. The consumer then clicks a virtual or physical button to complete the request message, and the computing device 152 communicates the request message to the controller 130 via the network 120.

The controller 130 analyzes the received request message and forwards the request message, or a portion thereof, to relevant vendors via the network 120 without providing personal contact information of the consumer. For example, the controller 130 may notify taxi companies and/or ride share companies that a possible fare is requested for the date of the concert to the concert venue. The controller 130 may also notify the concert venue to enable the venue to provide details about valet options on the night of the concert. The receiving vendors that provide transportation services can generate response messages that include offers specific to the consumer, such as estimated prices, promotional material, and/or the like. Similarly, the controller 130 can forward the request message, or a portion thereof, to restaurants in the vicinity of the concert venue, and the restaurants can use the DDE system 116 to generate response messages that include offers specific to that date, such as special or sale menu items on that date, a projected menu, and any promotional materials. Furthermore, if the consumer selected “artist merchandise and/or recordings”, the controller 130 can forward the request message, or a portion thereof, to merchants that sell merchandise and/or recordings (e.g., vinyl record albums, digital media, compact discs, and the like) related to the musical group or artist that is performing at the concert to be attended by the consumer. Such merchants can provide response messages that include offers for specific products associated with the musical group or artist, such as shirts, albums, digital media, videos of the performance or other performances, and the like.

As described above with respect to the first example, the controller 130 may forward the response messages that are received to the personal computing device 152 of the consumer or may compile information received from multiple response messages into a single offer message. For example, the offer message can have different tabs or sections for each of transportation, dining, and artist products, and one or more of the tabs can include multiple different offers from different vendors that communicated response messages.

In a third example, a consumer buys a ticket to a sports event at an out of town location and an airplane ticket that corresponds to the date of the sports event. The consumer can select these two purchases for upload to the DDE system 116 as a request message. The controller 130 of the DDE system 116 receives the request message and may connects to relevant vendors, such as the sports venue, hotels, restaurants, and transportation providers for offers. Optionally, the controller 130 may analyze purchasing information of other consumers to determine purchase trends of consumers that attend the sports event or related sports events. For example, if the sports event is periodic, such as an annual football game, then the controller 130 can analyze purchases made by consumers in the area of the sports venue on the day of the sports event in previous years to determine what other consumers have done while in town other than the sports event. The controller 130 can contact various vendors and receive offers and promotional materials in the form of response messages from the vendors. The controller 130 can generate an offer message that includes a list of activities and offers in the town for the consumer to consider. All of the activities and offers are applicable and available on the date or dates that the consumer will be in town. Such a list can generate an affiliation event of out of towners that share an interest in the sport. Hotels or restaurants can create special offers that are just for this group. Tourist bureaus, sightseeing merchants or other tourist attractions can connect with this group in advance with offers all via the DDE system 116.

In a fourth example, a consumer buys a prescription medication. Information about the medication can be selectively uploaded to the local data library 128. The medication information may be stored by the mobile application 146 in a specific medical emergency folder on the personal computing device 152. With prior consumer consent, the medical emergency folder may be accessible by emergency medical personnel to determine relevant medical historical information about the consumer, even if the consumer is incapacitated. This medical emergency folder may also include contact information for the consumer's doctor, such as in the form of doctor's office receipts. In a fifth non-limiting example, a consumer buys an expensive asset, such as a house, car, or valuable piece of jewelry or art. The mobile application 146, if selected by the consumer, stores detailed receipts about the assets in a financial folder of the memory 127. The financial folder may also include financial documents, such as tax records. With prior consumer consent, the financial folder may be made accessible to a designated attorney or heir in the event of the consumer's incapacitation or death. Alternatively, the medical emergency folder and/or financial folder may be stored in a data vault remote from the personal computing device 152 and managed by the DDE system 116.

In one or more embodiments, public or private clubs that are geographically removed can connect with offers that match their current patrons. For example, golf, tennis, and/or health clubs can have guest privileges for use of facilities and can share payment approval. Conventions can efficiently expand their auxiliary offers to patrons of the convention.

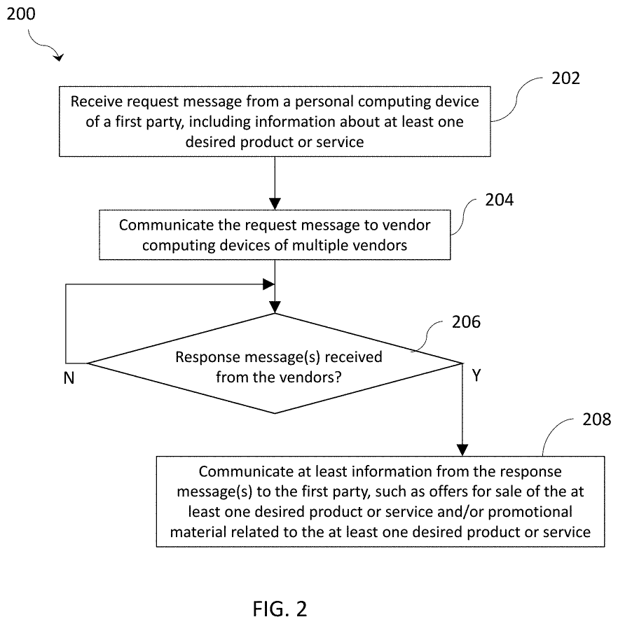

FIG. 2 is a flow chart 200 of a method for exchanging digital data according to an embodiment. Optionally, the method may include additional steps than shown in FIG. 2, fewer steps than shown in FIG. 2, and/or different steps than shown in FIG. 2. With additional reference to FIG. 1, the method begins at 202, at which a request message is received from a personal computing device of a first party. The request message is received at a controller that includes one or more processors. The request message includes information about at least one desired product or service. The request message may include at least one purchase receipt associated with a purchase made by the first party, such as a concert ticket receipt, sporting event ticket receipt, airline ticket receipt, restaurant receipt, grocery store receipt, coffee shop receipt, retailer receipt, or the like.

At 204, the request message is communicated to vendor computing devices of multiple vendors. The request message may be communicated by the controller, and the multiple vendors that receive the request message from the controller may be selected by the controller from a list or depository of available vendors that are accepting of such request messages. For example, the controller may analyze the information about the at least one desired product or service to determine whether each available vendor is relevant to the request message. Relevancy in this context refers to whether a given vendor makes, sells, offers for sale, or otherwise can facilitate a transaction with the first party for the first party to acquire the at least one desired product or service. Relevant vendors are vendors that do make, sell, offer for sale, or otherwise facilitate transactions for the first party to acquire the at least one desired product or service. Vendors that do not meet this threshold are non-selected vendors, and the controller does not communicate the request message to the non-selected vendors. In an embodiment, the controller communicated the request message to the vendor computing devices without revealing personal information of the first party to any of the vendors. For example, the contact address, email address, phone number, and name of the first party is not provided with any of the vendors, such that the first party is anonymous except for a unique identifier used by the DDE system.

At 206, a determination is made whether one or more response messages have been received from any of the vendors that received the request message from the controller. If no response messages have been received, the controller keeps waiting, such as for another designated time interval (e.g., 1 minute). If, on the other hand, at least one response message has been received, then the method continues to 208. At 208, in response to receiving one or more response messages from the vendor computing devices, the one or more response messages or information from the one or more response messages is communicated, via the controller, to the personal computing device of the first party. Each of the response messages includes at least one of (i) an offer for sale of the at least one desired product or service or (ii) promotional material related to the at least one desired product or service. Each of the response messages is generated upon receipt of the request message at the respective vendor computing device.

Optionally, the one or more response messages includes multiple response messages, and the method includes compiling, via the controller, the information from the multiple response messages into an offer message. The method may also include communicated the offer message to the personal computing device of the first party. Optionally, the compiling includes arranging the information from the multiple response messages in a list that is sorted based on price or proximity to the first party. The list may also identify the different vendors that responded by generating response messages.

Optionally, the method includes providing a graphical user interface, via a mobile application associated with the controller, on a display of the personal computing device of the first party to enable the first party to generate the request message. For example, the first party may be a consumer that interacts with the graphical user interface provided by the mobile application to select which products or services are desired. The consumer may select desired products and/or services, in part, by selecting items or elements from a local data library to be included in the request message. The local data library may be stored on the personal computing device and utilized by the mobile application. For example, the consumer can select a purchase receipt from the local data library as an indicator of one or more desired products or services. The method may also include displaying the one or more response messages or the information from the one or more response messages (e.g., in the offer message) on the graphical user interface. The method may also include, responsive to receiving a user input selection on the graphical user interface, storing (i) receipts from purchases made by the first party, (ii) promotional material that is sent to the first party, (iii) historical purchase data of the first party, and/or (iv) information about products or services that the first party desires to purchase in the local data library of a computer-readable storage medium of the personal computing device.

The above description is illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments and are merely example embodiments. Other embodiments and modifications may be apparent to those of ordinary skill in the art upon reviewing the above description. As used herein, the terms “including” and “in which” are used as the plain-English equivalents of the respective terms “comprising” and “wherein.” Moreover, terms such as “first,” “second,” “third,” “upper,” “lower,” “bottom,” “top,” etc. are used merely as labels, and are not intended to impose numerical or positional requirements on their objects.

What is claimed is:

1. A digital data exchange system comprising:
a controller including one or more processors and configured to receive a request message from a personal computing device of a first party, the request message including information about at least one desired product or service, the controller configured to communicate the request message to vendor computing devices of multiple vendors,
wherein, responsive to receiving one or more response messages from the vendor computing devices, the controller is configured to communicate the one or more response messages or information from the one or more response messages to the personal computing device of the first party,
wherein each of the one or more response messages includes one or more of an offer for sale of the at least one desired product or service or promotional material related to the at least one desired product or service, and is generated upon receipt of the request message at the respective vendor computing device.

2. The digital data exchange system of claim 1, wherein the controller is configured to not reveal personal information of the first party to any of the vendors.

3. The digital data exchange system of claim 1, wherein the one or more response messages includes multiple response messages and the controller is configured to compile the information from the multiple response messages into an offer message that is communicated to the personal computing device of the first party.

4. The digital data exchange system of claim 3, wherein the offer message provides the information from the multiple response messages in a list that is sorted based on price or proximity to the first party.

5. The digital data exchange system of claim 1, wherein the controller includes a computer-readable storage medium that includes a user profile database, wherein the user profile database contains a user profile associated with the first party.

6. The digital data exchange system of claim 5, wherein the user profile that is associated with the first party includes purchase receipts from purchases previously made by the first party and selectively uploaded by the first party to the computer-readable storage medium.

7. The digital data exchange system of claim 6, wherein the controller receives at least one of the purchase receipts in the request message.

8. The digital data exchange system of claim 1, wherein the controller is configured to communicate the request message to the vendor computing devices of the multiple vendors without communicating the request message to vendor computing devices of non-selected vendors, the non-selected vendors determined based on relevancy between the at least one desired product or service in the request message and products or services offered by the non-selected vendors.

9. The digital data exchange system of claim 1, further comprising a mobile application stored on the personal computing device of the first party, wherein the mobile application provides a graphical user interface utilized by the first party to generate the request message and display the one or more response messages or the information from the one or more response messages.

10. The digital data exchange system of claim 9, wherein the mobile application is communicatively connected to a local data library stored on a computer-readable storage medium of the personal computing device, wherein the local data library stores one or more of receipts from purchases made by the first party, promotional material that is sent to the first party, historical purchase data of the first party, or information about products or services that the first party desires to purchase.

11. A method for exchanging digital data, the method comprising:
receiving, at a controller that includes one or more processors, a request message from a personal computing device of a first party, the request message including information about at least one desired product or service;
communicating the request message to vendor computing devices of multiple vendors; and
responsive to receiving one or more response messages from the vendor computing devices, communicating, via the controller, the one or more response messages or information from the one or more response messages to the personal computing device of the first party,
wherein each of the one or more response messages includes one or more of an offer for sale of the at least one desired product or service or promotional material related to the at least one desired product or service, and is generated upon receipt of the request message at the respective vendor computing device.

12. The method of claim 11, wherein the controller is configured to communicate the request message to the vendor computing devices without revealing personal information of the first party to any of the vendors.

13. The method of claim 11, wherein the one or more response messages includes multiple response messages, and the method further comprises:
compiling, via the controller, the information from the multiple response messages into an offer message; and
communicating the offer message to the personal computing device of the first party.

14. The method of claim 13, wherein the compiling includes arranging the information from the multiple response messages in a list that is sorted based on price or proximity to the first party.

15. The method of claim 11, wherein receiving the request message from the personal computing device of the first party includes receiving at least one purchase receipt associated with a purchase made by the first party.

16. The method of claim 11, wherein communicating the request message to the vendor computing devices of the multiple vendors includes not communicating the request message to vendor computing devices of non-selected vendors, the non-selected vendors determined based on relevancy between the at least one desired product or service in the request message and products or services offered by the non-selected vendors.

17. The method of claim 11, further comprising:
providing a graphical user interface, via a mobile application associated with the controller, on a display of the personal computing device of the first party to enable the first party to generate the request message; and
displaying the one or more response messages or the information from the one or more response messages on the graphical user interface.

18. The method of claim 17, further comprising storing one or more of receipts from purchases made by the first party, promotional material that is sent to the first party, historical purchase data of the first party, or information about products or services that the first party desires to purchase in a local data library of a computer-readable storage medium of the personal computing device in response to receiving a user input selection on the graphical user interface.

19. A digital data exchange system comprising:
a controller including one or more processors and configured to receive a request message from a personal computing device of a first party, the request message including information about at least one desired product or service, the controller configured to communicate the request message to vendor computing devices of multiple vendors without revealing personal information of the first party to any of the vendors,
wherein, responsive to receiving multiple response messages from the vendor computing devices, the controller is configured to compile information from the response messages into an offer message and communicate the offer message to the personal computing device of the first party,
wherein each of the response messages includes one or more of an offer for sale of the at least one desired product or service or promotional material related to the at least one desired product or service, and is generated upon receipt of the request message at the respective vendor computing device.

20. The digital data exchange system of claim 19, wherein the controller is configured to compile the information from the response messages in a list that is sorted based on price or proximity to the first party.
